(19) United States
(12) Patent Application Publication
(10) Pub. No.: US 2023/0066640 A1
(43) Pub. Date: Mar. 2, 2023

(54) STROKE SIMULATOR

(71) Applicant: ADVICS CO., LTD., Kariya-shi, Aichi-ken (JP)

(72) Inventor: Masaki NAKAGAWA, Kariya-shi, Aichi-ken (JP)

(73) Assignee: ADVICS CO., LTD., Kariya-shi, Aichi-ken (JP)

(21) Appl. No.: 17/794,276

(22) PCT Filed: Jan. 29, 2021
(86) PCT No.: PCT/JP2021/003132

§ 371 Date: Jul. 21, 2022

(30) Foreign Application Priority Data
Jan. 30, 2020 (JP) 2020-013202

(51) Int. Cl. B60T 8/40

(52) U.S. Cl. CPC B60T 8/409

(57) ABSTRACT

The present disclosure includes: a cylinder; a piston that moves inside the cylinder in response to the operation of a brake pedal; a reactive rubber that is disposed inside the cylinder and that applies a reactive force to the piston by being compressed by the movement of the piston to one side; and a plug that is disposed inside the cylinder so as to surround an outer circumferential surface of the reactive rubber and that increases a sliding resistance against the movement of the reactive rubber to one side as the reactive rubber is compressed.

### TECHNICAL FIELD

The present disclosure relates to a stroke simulator.

### BACKGROUND ART

A stroke simulator is known as a device for generating a reactive force (load) in response to the operation of a brake pedal. A stroke simulator generally includes: a cylinder; a piston; and an elastic member that generates a reactive force. The elastic member is constituted of a spring and rubber, for example. For example, DE 10 2016 221 403 A1 describes a stroke simulator using rubber and a spring.

### CITATION LIST

### Patent Literature

PTL 1: DE 10 2016 221 403 A1

### SUMMARY

### Technical Problem

Here, when the piston shows the largest value in the range of movement and bottoms out, an impact applied when the piston comes into contact with a bottom surface might impair a driver's feeling during braking. For example, in the case where the relationship between the movement distance of the piston (pedal stroke) and the reactive force is a linear relationship, if a driver operates a brake pedal according to a predetermined gradient of increase in the tread force, the rate of change of gradient observed when the piston bottoms out increases.

The present disclosure aims to provide a stroke simulator capable of improving a feeling during operation at the time of bottoming.

### Solution to Problem

A stroke simulator of the present disclosure includes: a cylinder; a piston that moves inside the cylinder in response to an operation of a brake pedal; a reactive rubber that is disposed inside the cylinder and that applies a reactive force to the piston by being compressed by a movement of the piston to one side; and a plug that is disposed inside the cylinder so as to surround an outer circumferential surface of the reactive rubber and that increases a sliding resistance against a movement of the reactive rubber to the one side as the reactive rubber is compressed.

### Advantageous Effects of Disclosure

According to the present disclosure, the main reactive force (load) applied to the piston is the sum of the resilience of the reactive rubber and the friction force generated by the sliding resistance between the reactive rubber and the plug. Further, the sliding resistance between the plug and the reactive rubber increases as the piston moves to one side and compresses the reactive rubber. To put it differently, the friction force against the movement (deformation) of the reactive rubber increases and thus the reactive force increases as the piston becomes closer to the bottoming position. Thereby, the amount of increase in the reactive force relative to the movement of the piston increases as the piston becomes closer to the bottoming position. According to the present disclosure, it is possible to reduce an impact at the time of bottoming and improve a feeling during operation at the time of bottoming.

### BRIEF DESCRIPTION OF DRAWINGS

FIG. 1 is a configuration diagram (sectional view) of a stroke simulator of this embodiment.

FIG. 2 is a sectional view of reactive rubber of this embodiment taken along a plane orthogonal to its central axis.

FIG. 3 is a graph illustrating the relationship between a stroke and a reactive force of this embodiment.

FIG. 4 is a sectional view of reactive rubber according to a modification example of this embodiment taken along a plane orthogonal to its central axis.

### DESCRIPTION Of EMBODIMENTS

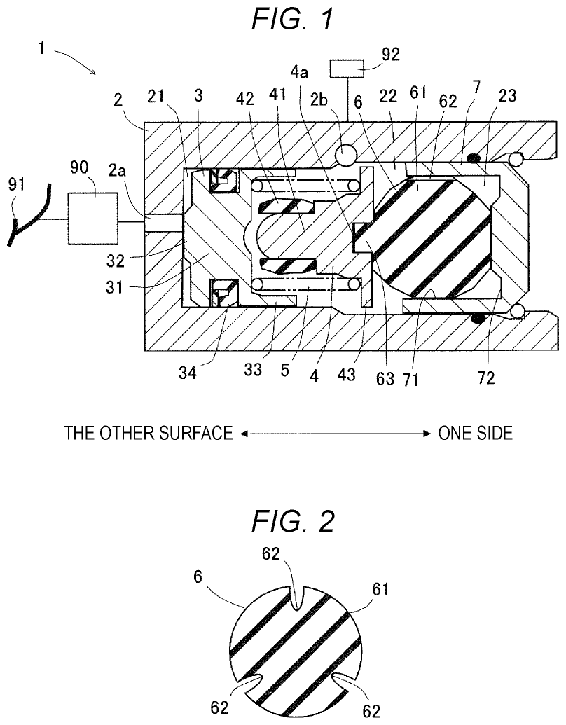

Hereinbelow, an embodiment of the present disclosure is described based on the drawings. The drawings used for the description are conceptual diagrams. In addition, the sectional views mainly illustrate sections, and lines supposed to be seen on the far side of the paper surface are partially omitted. Further, throughout the description, “one side” denotes one side of a cylinder 2 in the axial direction thereof (on the right side in FIG. 1), and “the other side” denotes the other side of the cylinder 2 in the axial direction thereof (on the left side in FIG. 1).

As illustrated in FIG. 1, a stroke simulator 1 of this embodiment includes: the cylinder 2; a piston 3; a stopper 4; a reactive force spring (corresponding to an “elastic member”) 5; reactive rubber 6; and a plug 7. The cylinder 2 is a bottomed cylindrical metallic cylinder member having an opening at one end portion (one side end portion) thereof and a bottom surface at the other end portion (the other side end portion) thereof. A through hole 2a is formed in the bottom surface of the cylinder 2.

The piston 3 is a columnar, metallic piston member. The piston 3 moves inside the cylinder 2 in response to the operation of a brake pedal 91. As an example, the brake pedal 91 is connected to the stroke simulator 1 through a hydraulic pressure chamber 90. The hydraulic pressure chamber 90 is formed of components such as a cylinder and a piston (not illustrated), for example. The hydraulic pressure chamber 90 has a configuration such that the piston moves inside the cylinder in response to the depression of the brake pedal 91 to cause fluid inside the cylinder to flow out. The hydraulic pressure chamber 90 is configured to supply fluid to the stroke simulator 1 in response to the stroke of the brake pedal 91.

The piston 3 is slid to one side by fluid that flows into the through hole 2a by the depression of the brake pedal 91. The piston 3 of this embodiment includes: a main body 31; a protruding portion 32 that protrudes to the other side from the center of the main body 31; a cylindrical portion 33 that protrudes in a cylindrical shape to one side from an outer circumferential portion of the main body 31; and an annular seal member 34 that is provided in an annular groove in an outer circumferential surface of the main body 31.

The main body 31 is formed in a columnar shape that extends along an inner circumferential surface of the cylinder 2. When the piston 3 is located at its initial position (stroke=0), the protruding portion 32 is in contact with the bottom surface of the cylinder 2 to form an input chamber 21 between the main body 31 and the bottom surface of the cylinder 2. The other end portion of the reactive force spring 5 is disposed on the radially inner side of the cylindrical portion 33. The seal member 34 is constituted of a cup seal and a resin-made backup ring, for example. The seal member 34 is in contact with the main body 31 and the inner circumferential surface of the cylinder 2 to seal the gap between the input chamber 21 and a first chamber 22 to be described later.

The stopper 4 is an intermediate member that is disposed between the piston 3 and the plug 7 through the reactive force spring 5. The stopper 4 is disposed inside the cylinder 2 so as not to be in contact with the inner circumferential surface of the cylinder 2. A concave portion 4a is formed in an end surface of the stopper 4 on one side thereof. The stopper 4 of this embodiment includes: a main body 41 that is a metallic columnar member; shock-absorbing rubber 42 that is provided on a portion of the main body 41 on the other side thereof; and a metallic annular flange portion 43 that protrudes radially outward from one end portion of the main body 41.

The concave portion 4a is formed at the center (on the central axis) of one end surface of the main body 41. A convex portion 63 to be described later is fitted into the concave portion 4a. The shock-absorbing rubber 42 is a rubber member for reducing an impact applied when the piston 3 and the stopper 4 come into contact with each other. The flange portion 43 supports one end portion of the reactive force spring 5.

The reactive force spring 5 is an elastic member that applies a reactive force to the piston 3 by being compressed by the movement of the piston 3 to one side. The reactive force spring 5 is disposed between the piston 3 and the stopper 4. The elastic coefficient of the reactive force spring 5 is smaller than the elastic coefficient of the reactive rubber 6. Note that, the “reactive force” in this disclosure can be rephrased as a “load” or “simulator load,” and the “compression” in this disclosure denotes compression in the axial direction.

The reactive rubber 6 is a rubber member that is disposed inside the cylinder 2 and that applies a reactive force to the piston 3 by being compressed by the movement of the piston 3 to one side. The reactive rubber 6 includes: a columnar main body 61; a communication groove 62 that is formed in the main body 61; and the convex portion 63 that is fitted into the concave portion 4a. An edge portion at each end of the main body 61 in the axial direction is chamfered. In other words, a chamfered portion is provided at each end portion of the main body 61 in the axial direction. An outer circumferential surface of the main body 61 (excluding the communication groove 62) is in contact with an inner circumferential surface of the plug 7. In addition, one end surface of the main body 61 is in contact with a bottom surface of the plug 7. The convex portion 63 is provided on the central axis of the reactive rubber 6. The central axis of the stopper 4 and the central axis of the reactive rubber 6 match each other by fitting the convex portion 63 and the concave portion 4a to each other.

As illustrated in FIGS. 1 and 2, the communication groove 62 is a groove (channel) that allows the first chamber 22 formed at one side of the reactive rubber 6 and a second chamber 23 formed at the other side of the reactive rubber 6 to communicate with each other inside the cylinder 2. The communication groove 62 is formed in a part of the outer circumferential surface of the main body 61 in the circumferential direction thereof. The communication groove 62 is a longitudinal groove extending in the axial direction. In this embodiment, multiple communication grooves 62 are formed in the circumferential direction at equal intervals. Note that the number of the communication grooves 62 may be one.

The first chamber 22 is defined by the inner circumferential surface of the cylinder 2, one end surface of the piston 3, the other end surface of the reactive rubber 6, and an opening end surface (the other end surface) of the plug 7. The stopper 4 and the reactive force spring 5 are arranged in the first chamber 22. The second chamber 23 is defined by one end surface of the reactive rubber 6, the bottom surface and inner circumferential surface of the plug 7.

In this embodiment, the input chamber 21, the first chamber 22, and the second chamber 23 are filled with fluid. In addition, a through hole 2b for connecting the first chamber 22 and an external reservoir 92 to each other is formed in the cylinder 2. The reservoir 92 accumulates fluid and is open to the atmosphere, that is, the reservoir 92 and the first chamber 22 are held at the atmospheric pressure.

The plug 7 is a member that is disposed inside the cylinder 2 so as to surround the outer circumferential surface of the reactive rubber 6 and that increases its sliding resistance against the movement of the reactive rubber 6 to one side as the reactive rubber 6 is compressed. The plug 7 is a bottomed cylindrical metallic member having a bottom surface at one end portion thereof and an opening at the other end portion thereof. The plug 7 is fixed to the one end portion of the cylinder 2 and covers the opening of the cylinder 2. A part of the inner circumferential surface of the plug 7 that is in contact with the reactive rubber 6 constitutes a sliding surface 71 for generating a sliding resistance. The sliding surface 71 indicates a portion of the inner circumferential surface of the plug 7 that is in contact with the reactive rubber 6. The bottom surface of the plug 7 and the one end surface of the reactive rubber 6 are in contact with each other.

A dent 72 is formed in an outer circumferential portion of the bottom surface of the plug 7. The dent 72 in this embodiment is formed at such a position as not to come into contact with the reactive rubber 6 when the piston 3 is located at its initial position. In other words, the dent 72 is formed at a position opposite the chamfered portion of the reactive rubber 6. The dent 72 may be formed annularly so as to surround a central portion of the bottom surface, or alternatively one or multiple dents may be formed in the bottom surface.

### Operation

Once the brake pedal 91 is depressed, fluid flows into the through hole 2a and pushes the piston 3. Then, when the pushing force of the piston 3 exceeds the reactive force of the reactive force spring 5, the piston 3 moves (slides) to one side with the reactive force spring 5 being compressed, whereby fluid flows into the input chamber 21. To put it differently, the reactive force spring 5 applies a reactive force to the piston 3 first in response to the movement of the piston 3. As illustrated in FIG. 3, the relationship between the stroke of the brake pedal 91 (the movement distance of the piston 3) and the reactive force, which is caused by the reactive force spring 5, is substantially a linear relationship. Note that, to be exact, a friction force caused by the sliding of the piston 3 and the like also constitute a reactive force.

Then, the piston 3 comes into contact with the stopper 4 by its movement to one side and attempts to move to one side together with the stopper 4. Once the piston 3 and the stopper 4 come into contact with each other, the other end surface of the stopper 4 which is a curved surface bulging to the other side is fitted into a concave curved surface formed in the one end surface of the piston 3. In this way, the piston 3 and the stopper 4 engage with (are fitted to) each other and thereby integrally move to one side.

In response to the operation of the brake pedal 91, the piston 3 and the stopper 4 move to one side while compressing the reactive rubber 6. The reactive rubber 6 attempts to bulge radially by being compressed in the axial direction. To put it differently, as the reactive rubber 6 is compressed in the axial direction, the pushing force of the reactive rubber 6 against the plug 7 increases. This increases the sliding resistance of the plug 7 against the movement (deformation) of the reactive rubber 6 to one side and also increases the friction force. In other words, as the reactive rubber 6 is compressed, it becomes harder to move (deform) to one side. As the reactive rubber 6 is compressed, the other end portion of the reactive rubber 6 becomes harder to move to one side. The reactive force applied to the piston 3 becomes a reactive force against the brake pedal 91 via fluid.

As illustrated in FIG. 3, the amount of increase in the reactive force of the reactive rubber 6 per unit amount of increase in the stroke of the brake pedal 91 increases as the stroke increases. The amount of increase in the reactive force per unit amount of increase in the stroke according to the feature of this embodiment is larger than the amount of increase in the reactive force per unit amount of increase in the stroke according to the feature (see a dotted line in FIG. 3) observed when a reactive force is generated only by the reactive rubber 6 after the piston 3 and the stopper 4 come into contact with each other. Further, according to the feature of this embodiment, the reactive force at the time of bottoming (the largest reactive force) is larger than that of the feature generated only by the reactive rubber 6 and having no friction force. The piston 3 bottoms out when the piston 3 moves to one side together with the stopper 4 and the stopper 4 comes into contact with the other end surface (the opening end surface) of the plug 7.

### Effect of this Embodiment

According to this embodiment, the main reactive force applied to the piston 3 is the sum of the resilience of the reactive rubber 6 and the friction force generated by the sliding resistance between the reactive rubber 6 and the plug 7. Further, the sliding resistance between the plug 7 and the reactive rubber 6 increases as the piston 3 moves to one side and compresses the reactive rubber 6. To put it differently, the friction force against the movement (deformation) of the reactive rubber 6 increases and thus the reactive force increases as the piston 3 becomes closer to the bottoming position (bottoming stroke). Thereby, the amount of increase in the reactive force per unit movement of the piston 3 increases as the piston becomes closer to the bottoming position. In other words, according to this embodiment, it is possible to reduce an impact at the time of bottoming and improve a feeling during operation at the time of bottoming.

In addition, this embodiment has such a configuration as to actively use the friction force between the reactive rubber 6 and the plug 7 as the reactive force. Specifically, as illustrated in FIG. 3, a movement distance (the stroke of the brake pedal 91) d2 of the piston 3 against which a reactive force is generated by the compression of the reactive rubber 6 is equal to or greater than a movement distance d1 of the piston 3 against which a reactive force is generated by the compression of an elastic member other than the reactive rubber 6 (the reactive force spring 5 in this embodiment) (d2≥d1). To put it another way, the stroke simulator 1 of this embodiment has such a configuration that a reactive force by the compression of the reactive rubber 6 (resilience+friction force) is generated across half or more of the range of movement (d1+d2) of the piston 3 (stroke).

This configuration enables the friction force of the plug 7 to act as a reactive force in a large section of the range of movement of the piston 3, and thus makes it possible to use the above feature more effectively (actively). Note that the elastic member other than the reactive rubber 6 may be constituted of multiple elastic members. In other words, the stroke simulator 1 includes one or multiple elastic members for generating a reactive force other than the reactive rubber 6, and the movement distance d2 in which the reactive rubber 6 acts is equal to or greater than the movement distance d1 in which other elastic members act.

In addition, since the reactive rubber 6 has the communication groove 62, fluid inside the second chamber 23 can be released to the first chamber 22 when the reactive rubber 6 moves. In other words, the movement of the reactive rubber 6 is not hampered by fluid in the second chamber 23, which helps implement the targeted feature.

Further, the stopper 4 and the reactive rubber 6 are fixed to each other by the concave portion 4a and the convex portion 63 fitted to each other. This reduces the axial displacement during movement of the stopper 4 which is not in contact with the inner circumferential surface of the cylinder 2. In other words, this configuration enables the stopper 4 to move in the axial direction precisely.

Furthermore, in this embodiment, the volume of the reactive rubber 6 observed when the piston 3 bottoms out (when the movement distance of the piston 3 becomes the largest value in the range of movement) is equal to or smaller than the capacity of the plug 7. In other words, the reactive rubber 6 compressed to a maximum extent within the range of movement of the piston 3 can be housed inside the plug 7. Thereby, it is possible to inhibit the reactive rubber 6 from protruding out of the plug 7 at the time of bottoming, and thus inhibit a foreign matter that causes galling from being generated.

### Others

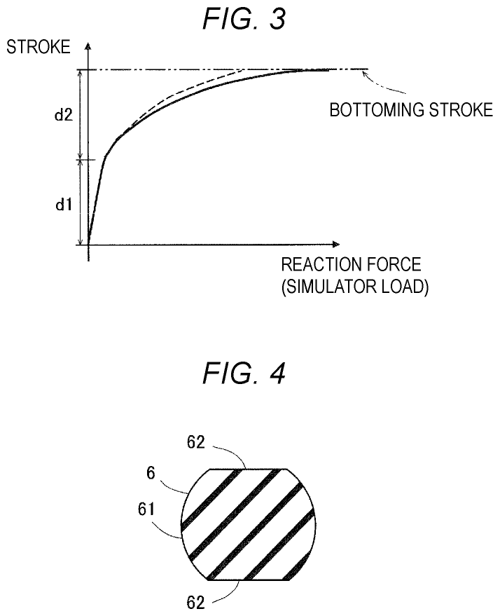

The present disclosure is not limited to the above embodiment. For example, as illustrated in FIG. 4, the communication groove 62 may be formed by chamfering an outer circumferential portion of the reactive rubber 6 (main body 61), or alternatively may have a shape formed in such a way that a part of the outer circumferential surface of the reactive rubber 6 is cut out so that a part of the reactive rubber 6 in the circumferential direction thereof is separated from the inner circumferential surface of the plug 7. In addition, the communication groove 62 may be formed in the inner circumferential surface of the plug 7, or alternatively may be formed in both the reactive rubber 6 and the plug 7. In other words, the communication groove 62 is only needed to be formed in at least one of the reactive rubber 6 and the plug 7. These configurations can also exhibit the same effect as that described above.

Meanwhile, the sliding surface 71 of the plug 7 may be a surface with surface roughness adjusted. For example, the sliding surface 71 may be a surface subjected to shot blasting treatment for the purpose of achieving predetermined surface roughness. Thereby, the friction force can be adjusted. Alternatively, the sliding surface 71 may be subjected to mirror finish treatment. By bringing the outer circumferential surface of the reactive rubber 6 excluding the communication groove 62 and the sliding surface 71 into close contact with each other, it is possible to inhibit fluid from entering between both surfaces and thus increase the friction force (sliding resistance).

Meanwhile, as to the pushing of the piston 3 by the depression of the brake pedal 91, the piston does not necessarily have to be pushed by fluid and may alternatively be pushed by a rod that operates in conjunction with the brake pedal 91. In addition, the concave portion 4a and the convex portion 63 may have any configuration as long as the stopper 4 and the reactive rubber 6 are fixed to each other so that their central axes match each other, and multiple sets of these portions may be formed around the central axes, for example. Further, the cylinder 2 (the first chamber 22 and the second chamber 23) may be filled with the air instead of fluid (brake fluid).

Meanwhile, the stopper 4 and the reactive force spring 5 do not necessarily have to be provided. In this case, for example, the piston 3 and the reactive rubber 6 are in contact with each other, and the piston 3 bottoms out when the piston 3 moves to one side and the piston 3 comes into contact with the opening end surface of the plug 7. With such a configuration, the friction force increases and the reactive force of the stroke simulator 1 increases as the reactive rubber 6 is compressed. Alternatively, it is also possible to use multiple elastic members other than the reactive rubber 6 to change the gradient of the reactive force (the amount of change per unit stroke) in multiple phases.

1. A stroke simulator comprising:
a cylinder;
a piston that moves inside the cylinder in response to an operation of a brake pedal;
a reactive rubber that is disposed inside the cylinder and that applies a reactive force to the piston by being compressed by a movement of the piston to one side; and
a plug that is disposed inside the cylinder so as to surround an outer circumferential surface of the reactive rubber and that increases a sliding resistance against a movement of the reactive rubber to the one side as the reactive rubber is compressed.

2. The stroke simulator according to claim 1, wherein a movement distance of the piston against which a reactive force is generated by the compression of the reactive rubber is equal to or greater than a movement distance of the piston against which a reactive force is generated by compression of an elastic member other than the reactive rubber.

3. The stroke simulator according to claim 2, wherein at least one of the reactive rubber and the plug has a communication groove formed therein, the communication groove allowing a first chamber formed at the one side of the reactive rubber and a second chamber formed at the other side of the reactive rubber to communicate with each other inside the cylinder.

4. The stroke simulator according to claim 3, further comprising:
an elastic member that applies a reactive force to the piston by being compressed by the movement of the piston to the one side; and
a stopper that is disposed between the piston and the plug through the elastic member, wherein
the stopper has a concave portion formed in an end surface thereof on the one side, and
the reactive rubber has a convex portion that is fitted into the concave portion.

5. The stroke simulator according to claim 4, wherein a volume of the reactive rubber observed when the piston bottoms out is equal to or smaller than a capacity of the plug.

6. The stroke simulator according to claim 1, wherein at least one of the reactive rubber and the plug has a communication groove formed therein, the communication groove allowing a first chamber formed at the one side of the reactive rubber and a second chamber formed at the other side of the reactive rubber to communicate with each other inside the cylinder.

7. The stroke simulator according to claim 6, further comprising:
an elastic member that applies a reactive force to the piston by being compressed by the movement of the piston to the one side; and
a stopper that is disposed between the piston and the plug through the elastic member, wherein
the stopper has a concave portion formed in an end surface thereof on the one side, and
the reactive rubber has a convex portion that is fitted into the concave portion.

8. The stroke simulator according to claim 7, wherein a volume of the reactive rubber observed when the piston bottoms out is equal to or smaller than a capacity of the plug.

9. The stroke simulator according to claim 2, further comprising:
an elastic member that applies a reactive force to the piston by being compressed by the movement of the piston to the one side; and
a stopper that is disposed between the piston and the plug through the elastic member, wherein
the stopper has a concave portion formed in an end surface thereof on the one side, and
the reactive rubber has a convex portion that is fitted into the concave portion.

10. The stroke simulator according to claim 9, wherein a volume of the reactive rubber observed when the piston bottoms out is equal to or smaller than a capacity of the plug.

11. The stroke simulator according to claim 1, further comprising:
an elastic member that applies a reactive force to the piston by being compressed by the movement of the piston to the one side; and
a stopper that is disposed between the piston and the plug through the elastic member, wherein
the stopper has a concave portion formed in an end surface thereof on the one side, and
the reactive rubber has a convex portion that is fitted into the concave portion.

12. The stroke simulator according to claim 11, wherein a volume of the reactive rubber observed when the piston bottoms out is equal to or smaller than a capacity of the plug.

13. The stroke simulator according to claim 1, wherein a volume of the reactive rubber observed when the piston bottoms out is equal to or smaller than a capacity of the plug.
